(19) United States
(12) Patent Application Publication
(10) Pub. No.: US 2024/0376253 A1
(43) Pub. Date: Nov. 14, 2024

(54) METHOD FOR MANUFACTURING RESIN COMPOSITION

(71) Applicant: CANON KABUSHIKI KAISHA, Tokyo (JP)

(72) Inventors: MIHO ISHII, Kanagawa (JP); HARUKA YAMAJI, Tokyo (JP); SATOSHI TSUTSUI, Kanagawa (JP)

(21) Appl. No.: 18/657,045

(22) Filed: May 7, 2024

(30) Foreign Application Priority Data
May 9, 2023 (JP) 2023-077010

(51) Int. Cl. C08G 59/68; C08G 59/22; C08G 59/40; C08G 59/62; C09J 163/00

(52) U.S. Cl. CPC C08G 59/687; C08G 59/22; C08G 59/4085; C08G 59/62; C09J 163/00

(57) ABSTRACT

A method for manufacturing a resin composition includes a heating step of heating a mixture containing an epoxy resin and a sulfonium salt, wherein the sulfonium salt has a structure denoted by General formula (1) and a cation portion having a molecular weight of 500 or more:

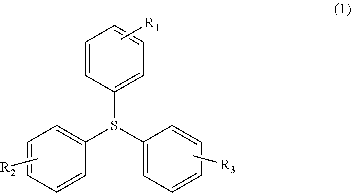

(each of R1 to R3 represents a hydrogen atom, a halogen atom, an alkyl, alkylthio, alkylcarbonyl, alkylsulfonyl, alkoxy, alkoxycarbonyl, aryl, arylcarbonyl, aryloxycarboaryl, aryloxy, arylthio, arylsulfinyl, hydroxy, hydroxy(poly)alkyleneoxy, acyloxy, cyano, nitro, heterocyclic hydrocarbon, silyl that may have a substituent, or amino group, R1 to R3 may be the same or differ from each other, and two or more of R1 to R3 may form a ring structure having an element S with each other directly or through —O—, —S—, —SO—, SO₂—, —NH—, —CO—, —COO—, —CONH—, an alkylene group, or a phenylene group).

### BACKGROUND

### Field of the Disclosure

The present disclosure relates to a method for manufacturing a resin composition.

### Description of the Related Art

To date, a photocationic polymerizable adhesive agent containing an epoxy resin as a primary component has been used as one type of adhesive agents used when an electronic component such as an IC chip is mounted on a wiring substrate. Such a photocationic polymerizable adhesive agent contains a photocationic polymerization initiator that generates a proton due to light so as to initiate cationic polymerization. However, when an electronic component is mounted on a wiring substrate, an instance in which a bonding portion by using the photocationic polymerizable adhesive agent is unable to be irradiated with light occurs frequently. In such an instance, a thermal cationic polymerizable adhesive agent capable of generating a proton due to only heat rather than light is used. Such a thermal cationic polymerizable adhesive agent contains a thermal cationic polymerization initiator that generates a proton due to heat so as to initiate cationic polymerization.

Japanese Patent Laid-Open No. 2014-31451 discloses an adhesive agent (resin composition) in which a sulfonium salt is used as a thermal cationic polymerization initiator. In general, when a highly sensitive polymerizable resin such as an alicyclic epoxy resin and a sulfonium salt are made into a single liquid, a reaction advances at normal temperature. Consequently, a pot life which is a usable time of an adhesive agent is decreased so that it is difficult to handle the adhesive agent. In this regard, to increase the pot life of the adhesive agent, a stabilizer is used in the resin composition in Japanese Patent Laid-Open No. 2014-31451.

However, when the stabilizer is used in the resin composition as described in Japanese Patent Laid-Open No. 2014-31451, a reactivity between the polymerizable resin and the sulfonium salt deteriorates, and there is a concern that adhesiveness of the resin composition to a substrate may deteriorate.

### SUMMARY

In consideration of the above-described issue, the present disclosure provides a method for manufacturing a resin composition having excellent storage stability while maintaining adhesiveness to a substrate.

To address the above-described issue, a method for manufacturing a resin composition according to the present disclosure includes a heating step of heating a mixture containing an epoxy resin and a sulfonium salt, wherein the sulfonium salt has a structure denoted by General formula (1) and a cation portion having a molecular weight of 500 or more.

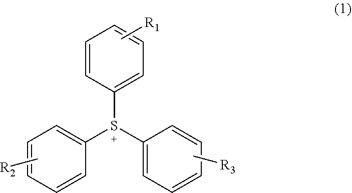

Each of R1 to R3 represents a hydrogen atom, a halogen atom, an alkyl group, an alkylthio group, an alkylcarbonyl group, an alkylsulfonyl group, an alkoxy group, an alkoxycarbonyl group, an aryl group, an arylcarbonyl group, an aryloxycarboaryl group, an aryloxy group, an arylthio group, an arylsulfinyl group, a hydroxy group, a hydroxy(poly)alkyleneoxy group, an acyloxy group, a cyano group, a nitro group, a heterocyclic hydrocarbon group, a silyl group that may have a substituent, or an amino group, and R1 to R3 may be the same or differ from each other. In this regard, two or more of R1 to R3 may form a ring structure having an element S with each other directly or through —O—, —S—, —SO—, SO₂—, —NH—, —CO—, —COO—, —CONH—, an alkylene group, or a phenylene group.

Further features of the present disclosure will become apparent from the following description of exemplary embodiments.

### DESCRIPTION OF THE EMBODIMENTS

Regarding an adhesive agent (resin composition) containing an epoxy resin as a primary component, in a known method, a photocationic polymerization initiator is contained and a bonding is performed by light irradiation from the viewpoint of reactivity and storage stability. On the other hand, when a bonding portion is unable to be irradiated with light, in a known method, a thermal cationic polymerization initiator capable of generating a proton due to only heat is used. Regarding the thermal cationic polymerization initiator, a compound capable of generating, due to heating, a cation species that initiates polymerization is used, and examples include quaternary ammonium salts, phosphonium salts, and sulfonium salts. In particular, sulfonium salts are selected as the thermal cationic polymerization initiator, and a sulfonium salt having benzyl sulfonium denoted by General formula (2) or a heterocycle derivative denoted by General formula (3) in a cation portion is used. However, when these are used, since a pot life of an adhesive agent (resin composition) is decreased, it is very difficult to control the adhesiveness to a substrate and the storage stability of the resin composition.

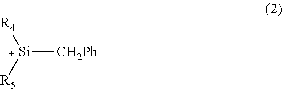

R₄ represents a phenyl group that may have a substituent, and R₅ represents an alkyl group.

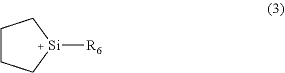

R₆ represents an alkyl group that may have a substituent.

According to the investigation by the present inventor, in general, of sulfonium salts used as the photocationic polymerization initiator, a compound having a specific structure functions as a thermal cationic polymerization initiator.

In addition, it was found that using such a sulfonium salt enables an adhesive agent (resin composition) having excellent storage stability while maintaining adhesiveness to a substrate to be provided. Specifically, heating a mixture containing an epoxy resin and a specific sulfonium salt enables a predetermined resin composition to be produced. A method for manufacturing a resin composition will be described below in detail with reference to an exemplary embodiment.

### Sulfonium Salt

A mixture according to the present embodiment contains a sulfonium salt. The sulfonium salt has a cation portion and an anion portion. To begin with, the cation portion will be described.

The sulfonium salt according to the present embodiment has a structure denoted by General formula (1) in the cation portion having a molecular weight of 500 or more.

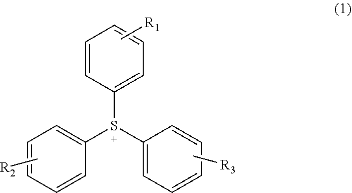

Each of R1 to R3 represents a hydrogen atom, a halogen atom, an alkyl group, an alkylthio group, an alkylcarbonyl group, an alkylsulfonyl group, an alkoxy group, an alkoxycarbonyl group, an aryl group, an arylcarbonyl group, an aryloxycarboaryl group, an aryloxy group, an arylthio group, an arylsulfinyl group, a hydroxy group, a hydroxy(poly)alkyleneoxy group, an acyloxy group, a cyano group, a nitro group, a heterocyclic hydrocarbon group, a silyl group that may have a substituent, or an amino group, and R1 to R3 may be the same or differ from each other. In this regard, two or more of R1 to R3 may form a ring structure having an element S with each other directly or through —O—, —S—, —SO—, SO₂—, —NH—, —CO—, —COO—, —CONH—, an alkylene group, or a phenylene group.

To date, in general, a triphenylsulfonium salt has been used as a photocationic polymerization initiator, and in a step of curing an epoxy resin, application of light such as ultraviolet rays has been required. Therefore, the triphenylsulfonium salt has not been used in a system in which curing is performed only by heating.

According to the investigation by the present inventor, it was found that, of sulfonium salts, a sulfonium salt having a structure denoted by General formula (1) in a cation portion having a molecular weight of 500 or more is capable of curing an epoxy resin by only heat treatment without performing a light irradiation step. Further, setting the skeleton of the cation portion to be a triphenylsulfone structure denoted by General formula (1) increases the degree of S—C bond compared with structures denoted by General formula (2) and General formula (3). In this regard, the molecular weight of the cation portion being 500 or more improves the stability to heat of the sulfonium salt.

Of the structures denoted by General formula (1), favorable specific examples are denoted by the following formula.

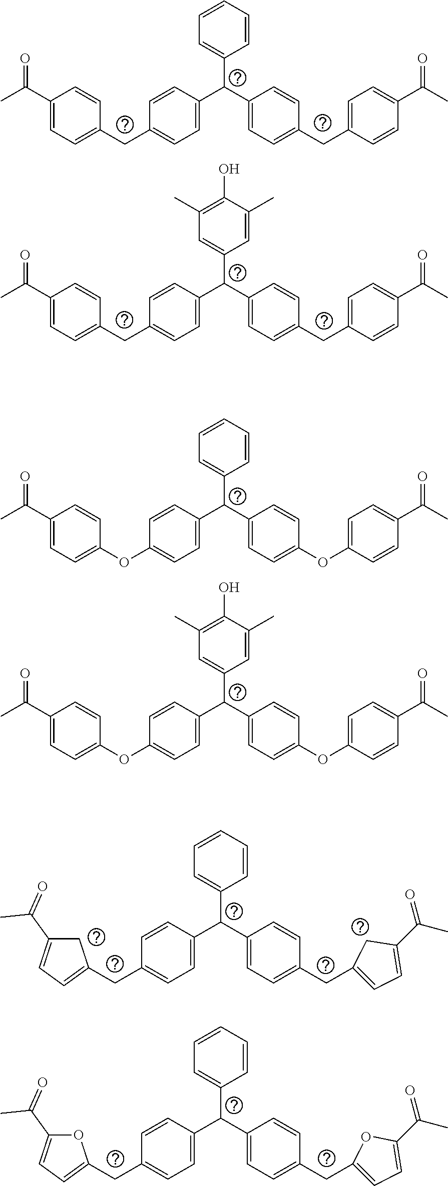

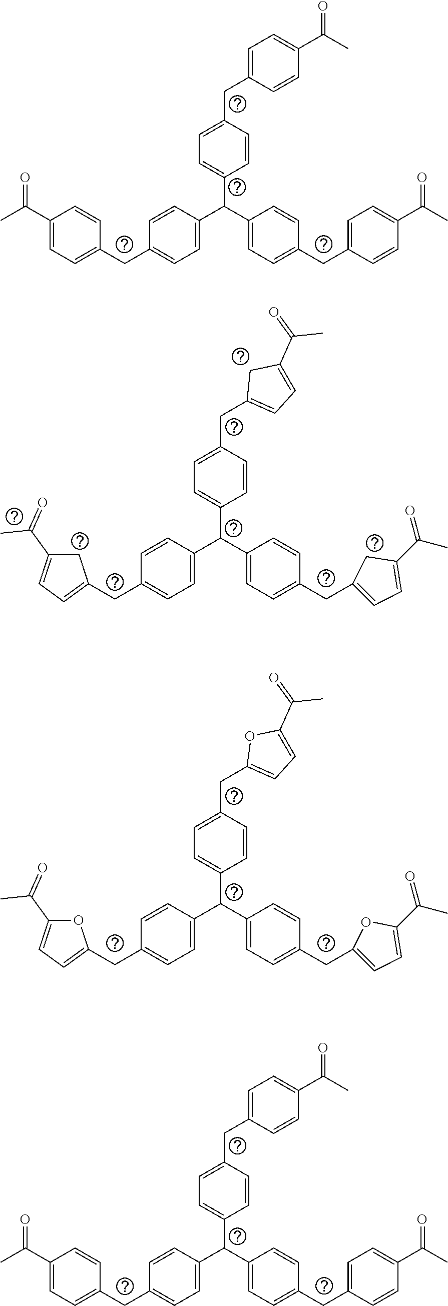

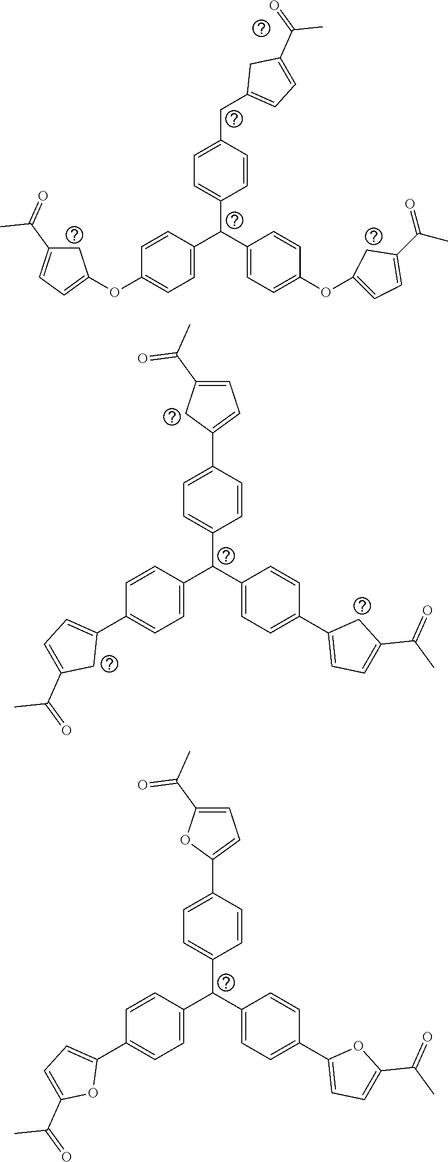

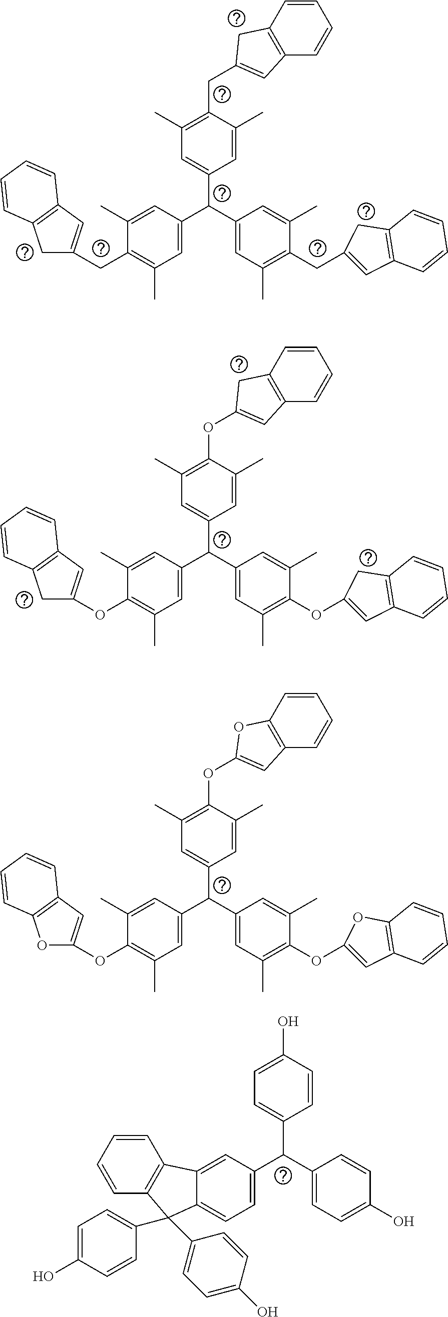

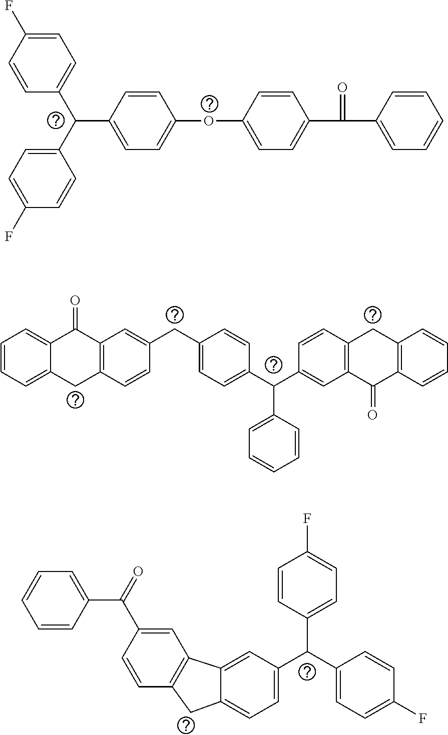

Next, the anion portion will be described. The anion portion of the sulfonium salt can contain at least one selected from the group consisting of SbF₆⁻, AsF₆⁻, PF₆⁻, (Rf)ₙPF₆₋ₙ⁻ (Rf represents a perfluoroalkyl group), BF₄⁻, and B(C₆F₅)₄⁻. From the viewpoint of adhesiveness between a produced resin composition and a substrate, SbF₆⁻, (Rf)ₙPF₆₋ₙ⁻, and B(C₆F₅)₄⁻ are suitably used, and in particular, the sulfonium salt can contain SbF₆⁻. In this regard, only one type of the sulfonium salts may be used, or two or more types thereof may be used in combination.

In addition, specific examples of the commercially available product include “ADEKA OPTOMER SP-172” (trade name) produced by ADEKA Corporation, “CPI-310A” (trade name) and “CPI-410S” (trade name) produced by San-Apro Ltd., and “Irgacure290” (trade name) produced by BASF. From the viewpoint of curability and adhesiveness to a substrate, the content of the sulfonium salt in a mixture of the sulfonium salt and an epoxy resin to be cured can be 0.1 to 30 parts by mass relative to 100 parts by mass of solid content of the epoxy resin added.

### Epoxy Resin

The mixture according to the present embodiment contains an epoxy resin. The epoxy resin according to the present embodiment can be a cation polymerization-type epoxy resin in consideration of adhesiveness of the resin composition, mechanical strength, and swelling resistance. More specific examples of the cationic polymerization-type epoxy resin include polyfunctional epoxy resins, that is, epoxy resins having an alicyclic skeleton, epoxy resins having a bisphenol skeleton, such as bisphenol A-type epoxy resins and bisphenol F-type epoxy resins, epoxy resins having a phenol novolak skeleton, such as phenol novolak-type epoxy resins, epoxy resins having a cresol novolak skeleton, such as cresol novolak-type epoxy resins, epoxy resins having a norbornene skeleton, epoxy resins having a terpene skeleton, epoxy resins having a dicyclopentadiene skeleton, and epoxy resins having an oxycyclohexane skeleton. Only one type of the epoxy resins may be used, or two or more types thereof may be used in combination.

To obtain predetermined curability by three-dimensionally cross-link a resin composition, the epoxy resin can contain a bifunctional or higher epoxy resin. In particular, the epoxy resin can contain a trifunctional or higher epoxy resin. Further, a trifunctional or higher to which at least one type of bifunctional epoxy resin is added can be used.

Regarding commercially available bifunctional epoxy resins, “jER1004” (trade name), “jER1007” (trade name), “jER1009” (trade name), “jER1010” (trade name), and “jER1256” (trade name) produced by MITSUBISHI CHEMICAL CORPORATION, “EPICLON 4050” (trade name) and “EPICLON 7050” (trade name) produced by DAINIPPON INK AND CHEMICALS, INCORPORATED, and the like are suitably used.

Regarding commercially available trifunctional or higher epoxy resins, “jER157S70” (trade name) and “jER1031S” (trade name) produced by MITSUBISHI CHEMICAL CORPORATION, “EPICLON N-695” (trade name) and “EPICLON N-865” (trade name) produced by DAINIPPON INK AND CHEMICALS, INCORPORATED, “CELLOXIDE2021” (trade name), “GT-300 Series”, “GT-400 Series”, and “EHPE3150” (trade name) produced by Daicel Corporation, “SU8” (trade name) produced by Nippon Kayaku Co., Ltd., “VG3101” (trade name) and “EPOX-MKR1710” (trade name) produced by PRINTEC CORPORATION, “DENACOL Series” produced by Nagase ChemteX Corporation, and the like are suitably used.

### Crosslinking Agent

The mixture according to the present embodiment can contain a polyol as the crosslinking agent. Herein, the polyol is a compound having at least two hydroxy groups in the molecule. The mixture containing the epoxy resin and the sulfonium salt containing the polyol enables the cationic polymerization of the epoxy resin to be accelerated and enables the stress of the resin composition resulting from a reaction between a ring-opened epoxy group and a hydroxy group to be decreased. That is, the adhesiveness of the resin composition to a substrate is effectively improved.

In this regard, from the viewpoint of solubility in a resin and a solvent and reactivity, the polyol can have a number-average molecular weight of 3,000 or less. Herein, the number-average molecular weight represents a simple average of the quantity of one polymer chain included in a polymer. Further, to avoid disappearance of the polyol during the step of heating the mixture containing the epoxy resin and the sulfonium salt, the number-average molecular weight of the polyol can be 200 or more. In this regard, the number-average molecular weight may be calculated in terms of polystyrene by a known method in which a gel permeation chromatograph (produced by SHIMADZU CORPORATION) is used. In addition, to avoid disappearance of the polyol during the step of heating the mixture containing the epoxy resin and the sulfonium salt, the polyol can have a boiling point of 200° C. or higher.

Specific examples of the polyol include commercially available polyethylene glycol (PEG) (200, 300, 400, 600, 1000, 2000) and the like provided by various companies. In addition, examples of the polyether polyol include “ADEKA POLYETHER P Series”, “BPX Series”, “G Series”, “SP Series”, “SC Series”, “CM Series”, “AM Series”, “EM Series”, “BM Series”, “PR Series”, and “GR Series” (all are trade names) produced by ADEKA Corporation. Examples of the polyol having a low molecular weight include 1,2- or 1,6-hexanediol, glycerin, trimethylolpropane, 3-methyl-1,5-pentanediol, 1,2,6-hexanetriol, 1,5-dihydroxypentan-3-on, 6-hydroxycaproic acid, 2-hydroxymethyl-1, and 3-propanediol. At least one of these may be used. In addition, two or more types of these may be used in combination.

### Silane Coupling Agent

The mixture according to the present embodiment can contain a silane coupling agent. Examples of the commercially available silane coupling agent include “A-187” (trade name) produced by Momentive Performance Materials Inc.

### Other Components

The mixture according to the present embodiment may contain other components within the bounds of not impairing the characteristics of the resin composition. Other components being contained enables the resin composition to be provided with predetermined characteristics.

For example, to adjust the curability and the reaction rate, sensitizing agents, basic substances such as amines, and acid-generation agent that generates a weakly acidic (pKa=−1.5 to 3.0) toluenesulfonic acid may be added to the mixture. Examples of the commercially available acid-generation agent that generates toluenesulfonic acid include “TPS-1000” (trade name) produced by Midori Kagaku Co., Ltd. and “WPAG-367” (trade name) produced by Wako Pure Chemical Industries, Ltd.

### Method for Manufacturing Resin Composition

A method for manufacturing the resin composition according to the present disclosure will be described. Initially, a step of mixing the epoxy resin and the sulfonium salt so as to prepare a mixture containing these is included. In this regard, the mixture may contain the above-described crosslinking agent (polyol), silane coupling agent, and other components. Thereafter, a dissolution step of dissolving the resulting mixture into a solvent may be included. Regarding the solvent, for example, propylene glycol monomethyl ether acetate (PGMEA) can be used. Subsequently, a heating step of heating the mixture containing the epoxy resin and the sulfonium salt is included. The mixture being heated enables a reaction to advance so as to produce a resin composition. The heating temperature in the heating step can be 90° C. or higher and 300° C. or lower. Herein, regarding the heating temperature in the heating step, it is sufficient that the temperature is increased to 90° C. or higher and 300° C. or lower, and there is no need to maintain the temperature of 90° C. or higher and 300° C. or lower throughout the heating step. In this regard, the heating time at the heating temperature can be an hour. When the heating temperature is 90° C. or lower, the resin composition is not sufficiently cured, and there is a concern that the adhesiveness to the substrate may deteriorate. On the other hand, when the heating temperature is 300° C. or higher, there is a concern that the epoxy resin may be decomposed. Further, the heating temperature in the heating step is more preferably 100° C. or higher and 250° C. or lower.

In this regard, when the dissolution step is performed, drying treatment for drying the solvent of the mixture can be performed before the step of heating the mixture. Examples of the temperature and the time of the drying treatment include heating at 90° C. for 5 min.

The resin composition according to the present disclosure may be produced by performing the above-described steps.

### EXAMPLES

Examples according to the present disclosure will be described below.

### Examples 1 to 27

Mixtures having compositions presented in Table 2 to Table 6 were applied to the respective substrates by a spin coating method, and a solvent was dried by performing drying treatment at 90° C. for 5 min. Further, a resin composition was obtained by performing a heating step of heating the mixture at a temperature presented in each Example.

### Comparative Examples 1 to 4

The resin composition was cured on the substrate in the manner akin to that in Example 1 except that a composition presented in Table 7 was used as a mixture.

The structures of the cation portions of the sulfonium salts used in Examples and Comparative examples are described below.

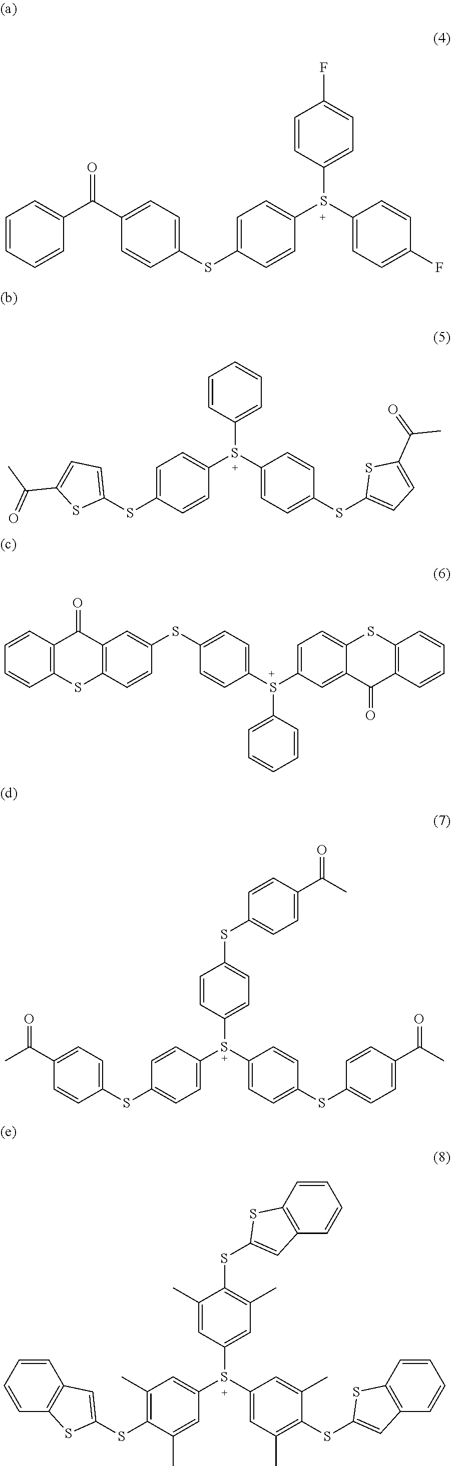

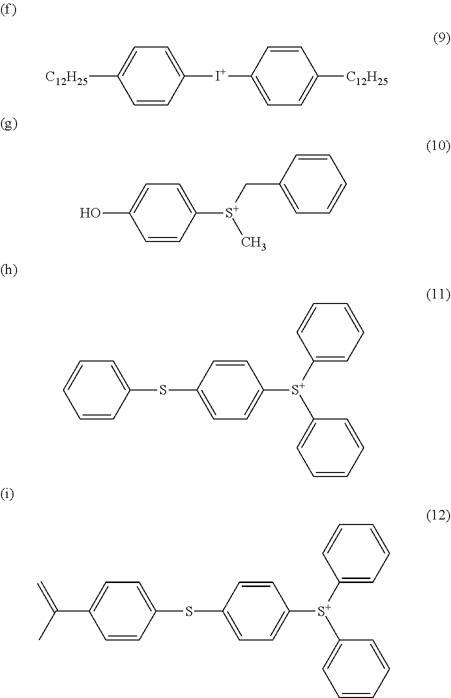

Table 1 is a table in which the cation portion and the anion portion of the sulfonium salt contained in the mixture are collectively presented.

TABLE 1

| Cation portion | | Anion portion | |
|---|---|---|---|
| Structure | Molecular weight | Structure | Sulfonium salt |
| a | 511.62 | SbF₆⁻ | a-1 |
| | | (Rf)ₙPF₆₋ₙ⁻ | a-2 |
| | | B(C₆F₅)₄⁻ | a-3 |
| | | BF₄⁻ | a-4 |
| | | PF₆⁻ | a-5 |
| | | AsF₆⁻ | a-6 |
| b | 575.81 | SbF₆⁻ | b-1 |
| c | 639.84 | SbF₆⁻ | c-1 |
| | | (Rf)ₙPF₆₋ₙ⁻ | c-2 |
| d | 713.96 | SbF₆⁻ | d-1 |
| | | B(C₆F₅)₄⁻ | d-2 |
| e | 840.26 | SbF₆⁻ | e-1 |
| f | 617.76 | SbF₆⁻ | f-1 |
| g | 231.33 | SbF₆⁻ | g-1 |
| h | 371.54 | SbF₆⁻ | h-1 |
| i | 411.60 | SbF₆⁻ | i-1 |

### Evaluation Method 1

Regarding the resin compositions produced by the methods in Examples 1 to 27 and Comparative examples 1 to 4, the adhesiveness to the substrate was evaluated. The resin composition was immersed in a 20%-by-weight 1,2-hexanediol aqueous solution and stored at 70° C., and presence or absence of peeling between the resin composition and the substrate was observed by using an optical microscope.
Adhesiveness ⊚: No peeling was observed after a lapse of a month
Adhesiveness ∘: Peeling was observed after a lapse of a week and within a month
Adhesiveness x: Peeling was observed within a week

### Evaluation Method 2

Regarding the resin compositions used in Examples 1 to 27 and Comparative examples 1 to 4, a change rate in the viscosity when the resin composition was stored at normal temperature was examined. In this regard, the viscosity was measured by using an E-type viscometer (produced by Toki Sangyo Co., Ltd.).
Storing stability ∘: a viscosity increase rate after a lapse of a month was less than 10%
Storing stability x: a viscosity increase rate after a lapse of a month was 10% or more

Table 2 to Table 7 present the evaluation result in each of Examples and Comparative examples.

TABLE 2

| | | Example | | | | | | | | | | | |
|---|---|---|---|---|---|---|---|---|---|---|---|---|---|
| | | 1 | 7 | 3 | 4 | 5 | 6 | 7 | 8 | 9 | 10 | 11 | 12 |
| Epoxy resin | N-695 | 100 | 100 | 100 | 100 | 100 | 100 | 100 | 100 | 100 | 100 | 100 | 100 |
| Sulfonium salt | a-1 | m | | | | | | | | | | | |
| | a-2 | | 3 | | | | | | | | | | |
| | a-3 | | | 3 | | | | | | | | | |
| | a-4 | | | | 3 | | | | | | | | |
| | a-5 | | | | | 3 | | | | | | | |
| | a-6 | | | | | | 3 | | | | | | |
| | b-1 | | | | | | | 3 | | | | | |
| | c-1 | | | | | | | | 3 | | | | |
| | c-2 | | | | | | | | | 3 | | | |
| | d-1 | | | | | | | | | | 3 | | |
| | d-2 | | | | | | | | | | | 3 | |
| | e-1 | | | | | | | | | | | | 3 |
| Solvent | PGMEA | 200 | 200 | 200 | 200 | 200 | 200 | 200 | 200 | 200 | 200 | 200 | 200 |

| | | | | | | | | | | | | |
|---|---|---|---|---|---|---|---|---|---|---|---|---|
| Mixture curing treatment | 200 | 200 | 200 | 200 | 200 | 200 | 200 | 200 | 200 | 200 | 200 | 200 |
| temperature (° C.) | | | | | | | | | | | | |
| Adhesiveness to substrate | ⊚ | ◯ | ◯ | ◯ | ◯ | ◯ | ⊚ | ⊚ | ◯ | ⊚ | ◯ | ⊚ |
| Storage stability | ◯ | ◯ | ◯ | ◯ | ◯ | ◯ | ◯ | ◯ | ◯ | ◯ | ◯ | ◯ |

TABLE 3

| Example | | 13 | 14 | 15 | 16 |
|---|---|---|---|---|---|
| Epoxy resin | N-695 | 100 | 100 | 100 | 100 |
| Sulfonium salt | a-1 | 0.05 | 0.1 | 30 | 35 |
| Solvent | PGMEA | 200 | 200 | 200 | 200 |

| | | | | |
|---|---|---|---|---|
| Mixture curing treatment | 200 | 200 | 200 | 200 |
| temperature (° C.) | | | | |
| Adhesiveness to substrate | ∘ | ⊚ | ⊚ | ∘ |
| Storage stability | ∘ | ∘ | ∘ | ∘ |

TABLE 4

| Example | | 17 | 18 | 19 |
|---|---|---|---|---|
| Epoxy resin | jER157S70 | 100 | | |
| | EHPE3150 | | 100 | |
| | N-695 | | | 100 |
| | jER1007 | | | 40 |
| Sulfonium salt | a-1 | 3 | 3 | 3 |
| Solvent | PGMEA | 200 | 200 | 200 |

| | | | |
|---|---|---|---|
| Mixture curing treatment temperature (° C.) | 200 | 200 | 200 |
| Adhesiveness to substrate | ⊚ | ⊚ | ⊚ |
| Storage stability | ∘ | ∘ | ∘ |

TABLE 5

| Example | | 20 | 21 | 22 | 23 |
|---|---|---|---|---|---|
| Epoxy resin | N-695 | 100 | 100 | 100 | 100 |
| | jER1007 | 40 | 40 | 40 | 40 |
| Sulfonium salt | a-1 | 3 | 3 | 3 | 3 |
| Crosslinking agent | PEG200 | 5 | | | |
| | PEG600 | | 5 | | 5 |
| | PEG1000 | | | 5 | |
| Silane agent | A-187 | | | | 5 |
| Solvent | PGMEA | 200 | 200 | 200 | 200 |

| | | | | |
|---|---|---|---|---|
| Mixture curing treatment temperature (° C.) | 200 | 200 | 200 | 200 |
| Adhesiveness to substrate | ⊚ | ⊚ | ⊚ | ⊚ |
| Storage stability | ∘ | ∘ | ∘ | ∘ |

TABLE 6

| Example | | 24 | 25 | 26 | 27 |
|---|---|---|---|---|---|
| Epoxy resin | N-695 | 100 | 100 | 100 | 100 |
| Sulfonium salt | a-1 | 3 | 3 | 3 | 3 |
| Solvent | PGMEA | 200 | 200 | 200 | 200 |

| | | | | |
|---|---|---|---|---|
| Mixture curing treatment temperature (° C.) | 90 | 100 | 250 | 300 |
| Adhesiveness to substrate | ∘ | ⊚ | ⊚ | ∘ |
| Storage stability | ∘ | ∘ | ∘ | ∘ |

TABLE 7

| Comparative example | | 1 | 2 | 3 | 4 |
|---|---|---|---|---|---|
| Epoxy resin | N-695 | 100 | 100 | 100 | 100 |
| | jER1007 | 40 | 40 | 40 | 40 |
| Cationic polymerization initiator | f-1 | 3 | | | |
| | g-1 | | 3 | | |
| | h-1 | | | 3 | |
| | i-1 | | | | 3 |
| Crosslinking agent | PEG600 | 5 | 5 | 5 | 5 |
| Silane agent | A-187 | 5 | 5 | 5 | 5 |
| Solvent | PGMEA | 200 | 200 | 200 | 200 |

| | | | | |
|---|---|---|---|---|
| Mixture curing treatment temperature (° C.) | 200 | 200 | 200 | 200 |
| Adhesiveness to substrate | ∘ | ∘ | x | x |
| Storage stability | x | x | ∘ | ∘ |

### Evaluation Result

As presented in Table 2 to Table 6, the methods according to the present examples provided resin compositions having excellent adhesiveness to the substrate and storage stability.

In Table 2, regarding Examples 1 to 12 in which the sulfonium salt having the structure denoted by General formula (1) in the cation portion having a molecular weight of 500 or more was used, favorable results were obtained with respect to the adhesiveness to the substrate and the storage stability. Regarding Examples 1, 7, 8, 10, and 12 in which the anion portion of the sulfonium salt had SbF₆⁻, in particular, excellent adhesiveness was exhibited.

In Table 3, Examples 14 and 15 in which the amount of the sulfonium salt added was 0.1 to 30 parts by mass relative to 100 parts by mass of the epoxy resin in the mixture exhibited favorable adhesiveness compared with Examples 13 and 16.

In Table 4, Examples 17 and 18 in which jER157S70 and EHPE3150, respectively, other than N-695 were used as the trifunctional or higher epoxy resin also exhibited favorable adhesiveness. In addition, Example 19 in which the trifunctional or higher epoxy resin and the bifunctional or higher epoxy resin were used in combination as the epoxy resin also exhibited favorable adhesiveness to the substrate.

In Table 5, regarding Examples 20 to 23 in which the polyol was contained as the crosslinking agent, the resin composition had favorable adhesiveness to the substrate. In this regard, the number-average molecular weight and the boiling point of the polyol used in each Example were as described below.
PEG200: number-average molecular weight of 190 to 210 and boiling point of 250° C. or higher
PEG600: number-average molecular weight of 570 to 630 and boiling point of 250° C. or higher
PEG1000: number-average molecular weight of 950 to 1050 and boiling point of 250° C. or higher

In addition, regarding Example 23 in which the silane coupling agent was used, the resin composition having favorable adhesiveness to the substrate was obtained.

In Table 6, regarding Examples 25 and 26 in which the curing temperatures of the mixtures were 100° C. and 250° C., respectively, the obtained resin composition had favorable adhesiveness to the substrate compared with Examples 24 and 27 in which the curing temperatures of the mixtures were 90° C. and 300° C., respectively.

On the other hand, In Table 7, regarding Comparative example 1 in which an iodonium salt instead of the sulfonium salt was used, the change rate in the viscosity after storage for a month was 10% or more. In addition, regarding Comparative example 2 in which the cation portion of the sulfonium salt did not have the structure denoted by General formula (1), the viscosity increased by 10% or more after storage for a week. Further, even when the cation portion of the sulfonium salt had the structure denoted by General formula (1), regarding Comparative examples 3 and 4 in which the molecular weight of the cation portion was less than 500, a resin composition having favorable adhesiveness to the substrate was not obtained.

Accordingly, the sulfonium salt contained in the mixture having the structure denoted by General formula (1) in the cation portion having a molecular weight of 500 or more enables the resin composition having excellent storage stability while maintaining adhesiveness to the substrate to be produced.

The resin composition according to the present disclosure is suitable for an adhesive agent to bond a flow-passage-forming substrate that forms a flow passage of an ink jet head to an ejection-opening-forming substrate that ejects a liquid. In addition, the resin composition according to the present disclosure is also suitable for an adhesive agent to bond a flow-passage-forming substrate that forms a flow passage of an ink jet head to a damper film (polyimide) for suppressing the liquid from vibrating.

A method for manufacturing a resin composition having excellent storage stability while maintaining adhesiveness to a substrate is provided.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-077010, filed May 9, 2023, which is hereby incorporated by reference herein in its entirety.

What is claimed is:

1. A method for manufacturing a resin composition comprising:
a heating step of heating a mixture containing an epoxy resin and a sulfonium salt,
wherein the sulfonium salt has a structure denoted by General formula (1) and a cation portion having a molecular weight of 500 or more: 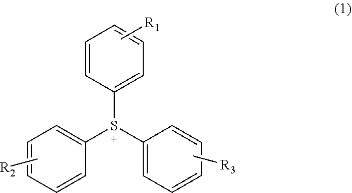
(each of R₁ to R₃ represents a hydrogen atom, a halogen atom, an alkyl group, an alkylthio group, an alkylcarbonyl group, an alkylsulfonyl group, an alkoxy group, an alkoxycarbonyl group, an aryl group, an arylcarbonyl group, an aryloxycarboaryl group, an aryloxy group, an arylthio group, an arylsulfinyl group, a hydroxy group, a hydroxy(poly)alkyleneoxy group, an acyloxy group, a cyano group, a nitro group, a heterocyclic hydrocarbon group, a silyl group that may have a substituent, or an amino group, R₁ to R₃ may be the same or differ from each other, and two or more of R₁ to R₃ may form a ring structure having an element S with each other directly or through —O—, —S—, —SO—, SO₂—, —NH—, —CO—, —COO—, —CONH—, an alkylene group, or a phenylene group).

2. The method for manufacturing a resin composition according to claim 1,
wherein the heating temperature in the heating step is 90° C. or higher and 300° C. or lower.

3. The method for manufacturing a resin composition according to claim 1,
wherein the heating temperature in the heating step is 100° C. or higher and 250° C. or lower.

4. The method for manufacturing a resin composition according to claim 1,
wherein the epoxy resin contains a trifunctional or higher epoxy resin.

5. The method for manufacturing a resin composition according to claim 1,
wherein the epoxy resin contains a bifunctional epoxy resin.

6. The method for manufacturing a resin composition according to claim 1,
wherein the epoxy resin contains at least one selected from the group consisting of an epoxy resin having an alicyclic skeleton, an epoxy resin having a bisphenol skeleton, an epoxy resin having a phenol novolak skeleton, an epoxy resin having a cresol novolak skeleton, an epoxy resin having a norbornene skeleton, an epoxy resin having a terpene skeleton, an epoxy resin having a dicyclopentadiene skeleton, and an epoxy resin having an oxycyclohexane skeleton.

7. The method for manufacturing a resin composition according to claim 1,
wherein the anion portion of the sulfonium salt contains at least one selected from the group consisting of SbF₆⁻, AsF₆⁻, PF₆⁻, (Rf)ⁿPF₆₋ₙ⁻ (Rf represents a perfluoroalkyl group), BF₄⁻, and B(C₆F₅)₄⁻.

8. The method for manufacturing a resin composition according to claim 1,
wherein the anion portion of the sulfonium salt is SbF₆⁻.

9. The method for manufacturing a resin composition according to claim 1,
wherein the content of the sulfonium salt in the mixture is 0.1 to 30 parts by mass relative to 100 parts by mass of the solid content of the epoxy resin.

10. The method for manufacturing a resin composition according to claim 1,
wherein the mixture contains a polyol having at least two hydroxy groups in the molecule.

11. The method for manufacturing a resin composition according to claim 10,
wherein a number-average molecular weight of the polyol is 3,000 or less.

12. The method for manufacturing a resin composition according to claim 10,
wherein a number-average molecular weight of the polyol is 200 or more.

13. The method for manufacturing a resin composition according to claim 10,
wherein the polyol has a boiling point of 200° C. or higher.

14. The method for manufacturing a resin composition according to claim 1,
wherein the mixture contains a silane coupling agent.

15. The method for manufacturing a resin composition according to claim 1,
wherein the mixture contains a solvent.

16. The method for manufacturing a resin composition according to claim 15,
wherein the solvent is propylene glycol monomethyl ether acetate.
